(19) United States
(12) Patent Application Publication
(10) Pub. No.: US 2019/0318188 A1
(43) Pub. Date: Oct. 17, 2019

(54) IMAGE SKEW IDENTIFICATION

(71) Applicant: ENT. SERVICES DEVELOPMENT CORPORATION LP, Houston, TX (US)

(72) Inventor: Joseph MILLER, Boulder, CO (US)

(73) Assignee: ENT. SERVICES DEVELOPMENT CORPORATION LP, Houston, TX (US)

(21) Appl. No.: 16/073,989

(22) PCT Filed: Jan. 29, 2016
(86) PCT No.: PCT/US16/15619

§ 371 Date: Jul. 30, 2018

(51) Int. Cl. G06K 9/32; G06K 9/46; G06K 9/62; G06T 7/50

(52) U.S. Cl. CPC G06K 9/3275; G06K 9/4642; G06K 2209/25; G06T 7/50; G06K 9/6212; G06K 9/6202

(57) ABSTRACT

A device including an eligibility engine to receive, and determine an eligibility of, a target object image. The device includes a comparison engine to compare to a monochromatic threshold representation of the target object image to each skew pattern of a library of pre-generated skew patterns associable with a reference object image to identify which pre-generated skew pattern best matches the monochromatic threshold representation of the target object image.

### BACKGROUND

Automated image recognition may enhance numerous tasks, whether they occur in a commercial or consumer setting. In some instances, such image recognition aids human decision-making and/or facilitates further automated processes.

### BRIEF DESCRIPTION OF THE DRAWINGS

FIG. 1 is a block diagram schematically representing skew detection relative to a target object image, according to one example of the present disclosure.

FIG. 2 is a block diagram schematically representing an imaging system in association with skew detection, according to one example of the present disclosure.

FIG. 3 is a diagram schematically representing an imager orthogonal relative to a target object, according to one example of the present disclosure.

FIG. 4 is a diagram schematically representing an imager at non-orthogonal angle relative to a target object, according to one example of the present disclosure.

FIG. 5 is a diagram schematically representing a reference object image or target object image without skew, according to one example of the present disclosure.

FIG. 6 is a diagram schematically representing a target object image with skew, according to one example of the present disclosure.

FIG. 7 is a diagram schematically representing an imaging angle of attack relative to a target object, according to one example of the present disclosure.

FIG. 8 is a block diagram schematically representing a device, according to an example of the present disclosure.

FIG. 9 is a block diagram schematically representing a device, according to an example of the present disclosure.

FIG. 10 is a block diagram schematically representing an eligibility engine, according to an example of the present disclosure.

FIG. 11 is a block diagram schematically representing a comparison engine, according to an example of the present disclosure.

FIG. 12 is a block diagram schematically representing conversion of a target object image to a monochromatic threshold representation, according to an example of the present disclosure.

FIG. 13 is a block diagram schematically representing application of a non-affine transform to a coordinate data array, according to an example of the present disclosure.

FIG. 14 is a block diagram schematically representing a plurality of pre-generated skew patterns, according to an example of the present disclosure.

FIG. 15 is a block diagram schematically representing a library of reference object images, according to an example of the present disclosure.

FIG. 16 is a block diagram schematically representing generation of an array of pixel of occlusion maps and their association with a reference object image, according to an example of the present disclosure.

FIG. 17 is a block diagram schematically representing at least some aspects of operation of a comparison engine to identify a degree of skew, according to an example of the present disclosure.

FIG. 18 is a block diagram schematically representing a determination engine, according to an example of the present disclosure.

FIG. 19 is a block diagram schematically representing a control portion, according to an example of the present disclosure.

FIG. 20 is a block diagram schematically representing a method of identifying a degree of skew, according to an example of the present disclosure.

FIG. 21 is a block diagram schematically representing a method of identifying skew, according to an example of the present disclosure.

### DETAILED DESCRIPTION

In the following detailed description, reference is made to the accompanying drawings which form a part hereof, and in which is shown by way of illustration specific examples which may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

At least some examples of the present disclosure provide for detecting (e.g. identifying) skew in a target object image. In some examples, upon detecting skew and the degree of skew, further information may be determined from or about the target object image. In some instances, the degree of skew detected may determine whether radial histogram matching may be performed between a target object image and a reference object image. In some instances, the detection of skew or the degree of skew detected may result in a notification to a user (or to an automated imaging system) to re-perform imaging of the target object using a modified technique, such as a different angle of attack and/or other variables which may reduce skew in subsequently capture images.

In at least one aspect, skew may hinder accurate recognition of an object (or feature of an object) because as an object is skewed part of the image changes position in the third dimension. For instance, it is commonly observed that as things get further away they get smaller. Accordingly, this size difference within an image may be significant enough to impact the accuracy of a pattern match of a target object image with a reference object image.

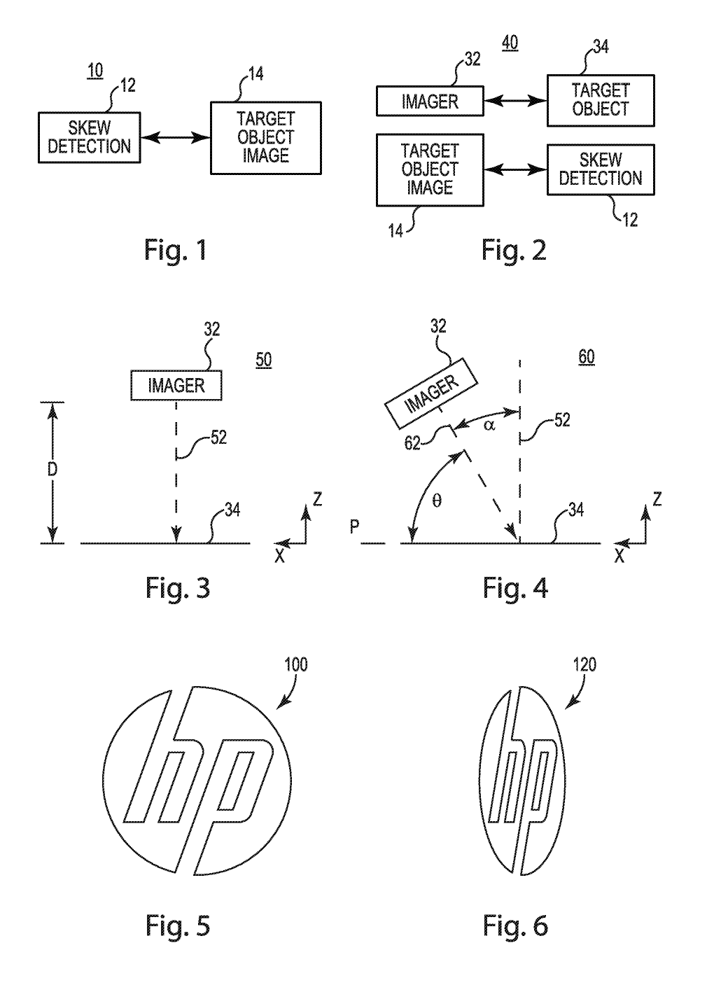

At least these examples, and additional examples, are described throughout the present disclosure in association with at least FIGS. 1-21.

As shown in FIG. 1, an arrangement 10 is provided to apply skew detection 12 to a target object image 14. At least some examples of such skew detection are implemented via various methods and/or devices, as described throughout the present disclosure. In at least some examples, detection of skew in a target object image 14 may enhance and/or enable image recognition functionality and/or subsequent processes.

FIG. 2 is block diagram of an imaging system 30 in association with arrangement 10, according to an example of the present disclosure. As shown in FIG. 2, system 30 includes imager 32 for obtaining an image of target object 34, thereby producing a target object image 14 to which skew detection 12 may be applied. The imager 32 may be a camera, sensor, or other type of imaging resource.

FIG. 3 is a diagram 50 schematically representing an imager orthogonal relative to a target object image, according to one example of the present disclosure. As shown in diagram 50, an imager 32 is positioned with its line of sight 52 orthogonal to a surface of target object 34 such that imager 32 can produce a target object image 14 without skew. In one example, such a target object image 14 may have an appearance such as shown by the logo 100 (e.g. a HP logo) in FIG. 5. However, it will be understood that target object 34 may include target objects of a wide variety of two-dimensional or three-dimensional shapes, sizes, colors, textures, etc.

In another aspect, the logo 100 in FIG. 5 may also be referred to as a reference object image of a reference object because of the lack of skew present.

FIG. 4 is a diagram 60 schematically representing an imager at non-orthogonal angle relative to a target object, according to one example of the present disclosure. As shown in diagram 60, an imager 32 is positioned with its line of sight 62 non-orthogonal to a surface of target object 34 such that imager 32 may produce a target object image 14 with skew. In one example, such a target object image 14 may have an appearance such as shown by the skewed logo 120 (e.g. skewed HP logo) in FIG. 6. As shown in FIG. 4, at least one factor contributing to the skew includes the angle of attack of imager 32, which may be expressed as angle (α) relative to an orthogonal reference (e.g. line of sight) 52 or which may be expressed as an angle (θ) relative to plane P through which at least a portion of target object 34 passes.

It will be understood that the logos 100, 120 shown in FIGS. 5-6 provide just one example of a target object image. It also will be understood that any given target object image may comprise one feature or may comprise multiple features. The feature or features may be recognizable via automated image recognition processes and/or via supervisory machine learning, such as a user clicking on a region of interest.

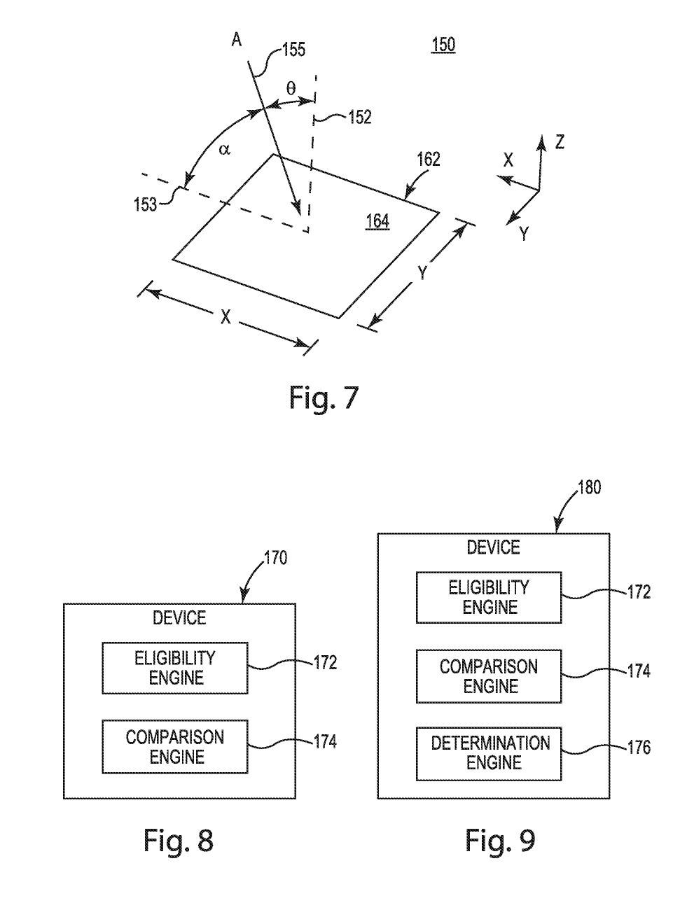

FIG. 7 is a diagram 150 schematically representing an imaging angle of attack relative to a target object, according to one example of the present disclosure. As shown in diagram 150, the target object 162 has a surface 164 with dimensions extending in at least an x orientation and a y orientation to produce a two-dimensional (2D) target object image having an X component and a Y component. While surface 164 is shown as being generally planar for illustrative simplicity, it will be understood that in some examples surface 164 may exhibit varying topology and may or may not exhibit a repeating pattern. In some examples, surface 164 may be a surface of a tire (for an automobile, truck, etc.) having a tessellating pattern. As further shown in diagram 150, line A represents a line of sight 155 at which an imager obtains a target object image. In one aspect, the angle of attack may be expressed in a manner similar to that previously described in association with at least FIG. 4.

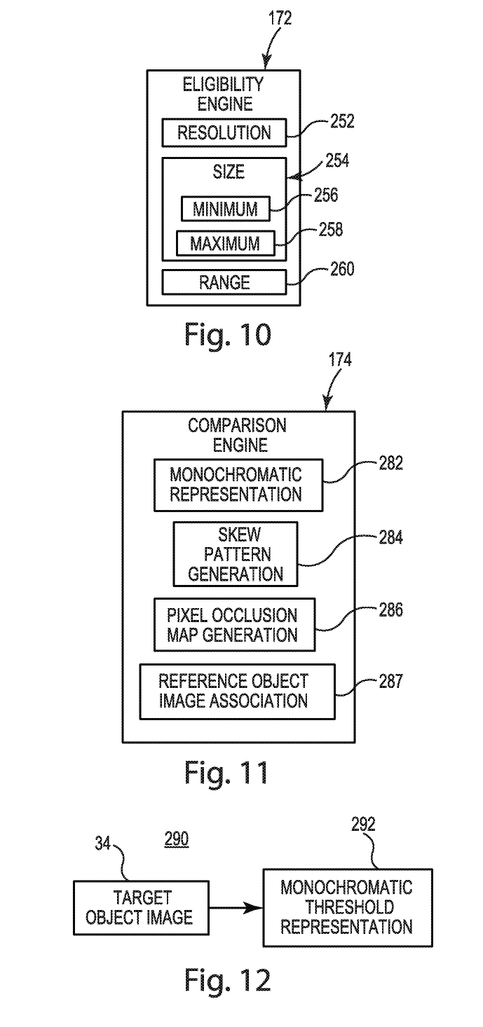

FIG. 8 is a block diagram schematically representing a device 170 for detecting skew, according to an example of the present disclosure. As shown in FIG. 8, in some examples device 170 includes an eligibility engine 172 and a comparison engine 174. In some examples, the eligibility engine 172 takes the form and/or functionality as described later in association with at least FIG. 10. In general terms, eligibility engine 172 can enable determination of whether a particular target object image is eligible (e.g. suitable) for detecting skew via device 170. In some examples, the comparison engine 174 takes the form and/or functionality as described later in association with at least FIGS. 11-17. In general terms, the comparison engine 174 can enable detecting skew and/or a degree of skew.

FIG. 9 is a block diagram schematically representing a device 180 for detecting skew, according to an example of the present disclosure. As shown in FIG. 9, in some examples device 180 includes the eligibility engine 172 and the comparison engine 174 of device 170 and additionally includes a determination engine 180. In some examples, the determination engine 180 may leverage detection of skew and/or degree of skew identified (via at least the comparison engine 174) to permit a go, no-go decision for subsequent processes based on whether skew was detected in the target object image and to what degree. In some examples, determination engine 180 takes the form and/or functionality as described later in association with at least FIG. 18.

In some examples, device 170, 180 (FIGS. 7,8) may comprise a portion of (e.g. be incorporated within) an imager, such as imager 32 in FIG. 2 or may be external to such an imager but in communication with the imager. In some examples, device 170 may be incorporated into additional/other image recognition elements and/or may stand alone from such additional/other image recognition elements but be in communication with them.

In some examples, devices 170, 180 may include at least engines 172, 174, and/or 176, which may be any combination of hardware and programming to implement the functionalities of the engines described herein. In examples described herein, such combinations of hardware and programming may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one engine of device 170, 180. In some examples, the at least one machine-readable storage medium may store instructions that, when executed by the at least one processing resource, at least partially implement some or all engines of device 170, 180. In such examples, device 170, 180 may include the at least one machine-readable storage medium storing the instructions and the at least one processing resource to execute the instructions. In some examples, the functionalities of any engines of device 170, 180 may be at least partially implemented in the form of electronic circuitry.

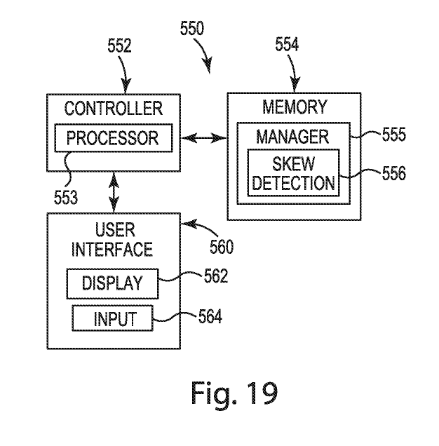

In some examples, the operation and/or functionality of eligibility engine 172, comparison engine 174, and/or determination engine 176 are implemented via and/or controllable via at least some aspects of control portion 550 (including manager 555) as later described in association with at least FIG. 19.

FIG. 10 is a block diagram schematically representing one example implementation of the eligibility engine 172 of FIGS. 7-8. In some examples, eligibility engine 172 includes a resolution element 252, a size element 254, and/or a range element 260.

In some examples, the resolution element 252 can permit specifying a selectable minimum (or maximum) resolution of the target object image for which skew detection may be applied. In some instances, the resolution may be expressed as dots-per-inch (DPI) or via other units. In some examples, the size element 254 can enable selection and application of a minimum size parameter (256) and maximum size parameter (258) of the target object image. In one aspect, the size element 254 may facilitate the application of skew detection to appropriately sized target object images, which thereby may minimize false positives. In some examples, the range element 260 can specify a permissible range of capture, which may reduce false positives in detecting skew. In one aspect, the range of capture refers to a distance between the imager and the target object at the time of capturing an image.

Accordingly, in at least some examples the eligibility engine 172 may function according to at least one operating principle that detection of an object may involve knowing what the object will look like at a given distance, in regard to size, etc. In some examples, such an assessment of the data capture process may be sufficient to determine the variables of DPI, minimum and maximum logo size (for any given logo), etc. With these values it is possible to apply a bounds and constraints to the pre-generation of skew patterns (e.g. templates), which is further described later.

For instance, via the resolution element 252 which may specify a DPI range, the eligibility engine 172 may ensure that a target object image captured within an area (that is to be detected) will be no larger than a selectable value, and no smaller than a selectable value. By reviewing the skew possibilities, it also can be deduced how many different skew patterns would be needed to detect (at a specific level of accuracy) one or more of the actual instances of the data when captured by a sensor (e.g. imager 32 or other system). However, it will be understood that, in doing so, the eligibility engine 172 does not consider the actual target object image at this time, but rather the actual array of data which would contain pixels. Accordingly, via these at least these aspects of the eligibility engine 172, a bounds and constraints may be applied to the pre-generation of skew patterns (e.g. templates).

Via at least the resolution element, size element 254, and/or range element 260, the eligibility engine 172 may determine eligibility of a target object image for the application of skew detection as further described herein. However, it will be understood that eligibility engine 172 is not strictly limited to the resolution element 252, size element 254, and/or the range element 260, such that additional or other factors may be employed to determine eligibility of a target object image for the application of skew detection, according to at least some examples of the present disclosure.

FIG. 11 is a block diagram schematically representing one example implementation of the comparison engine 174 of FIGS. 7-8. As shown in FIG. 11, in some examples the comparison engine 174 includes a monochromatic representation element 282, a skew pattern generation element 284, a pixel occlusion map generation element 286, and/or a reference object image association element 287.

As shown in FIG. 11, in some examples the monochromatic representation element 282 of the comparison engine 174 converts a target object image 34 into a monochromatic threshold representation 292, as schematically represented by the diagram 290 in FIG. 12. In some examples, the monochromatic threshold representation 292 may be considered a monochromatic bitmap of the target object image (or a portion thereof) resulting from application of a threshold of values for a particular color exhibited in the target object image. For instance, the target object image (or a selected portion thereof) may exhibit at least one color (e.g. red) such that application of the threshold monochromatic representation element 282 retains pixels having a color range value (between 0 and 255) greater than a minimum parameter (e.g. 64 in one example) and less than a maximum parameter (e.g. 196 in one example). The retained pixels are then represented as white pixels relative to a black background, with color pixels outside of the respective minimum and maximum parameters being disregarded and represented via black pixels. The result is a bitmap exhibiting a pattern of the target object image (or a selected portion thereof) in monochromatic (e.g. black and white in this example) representation and which can later be compared to other monochromatic representations, such as pixel occlusion maps derived from pre-generated skew patterns, as more fully described later in the present disclosure.

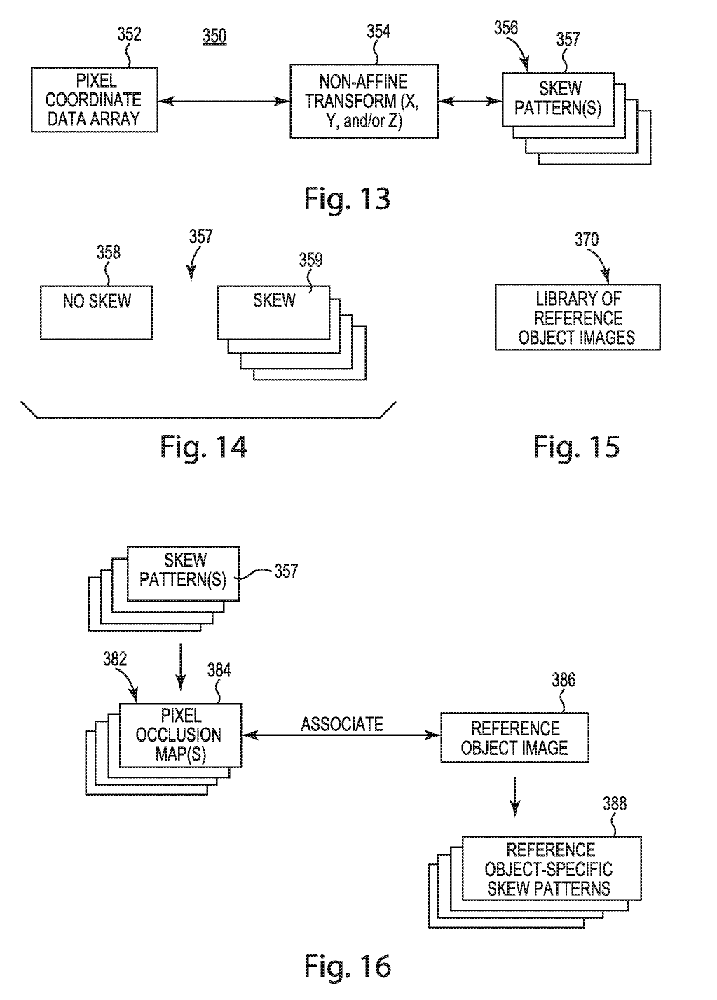

As previously noted, in some examples the comparison engine 174 includes a skew pattern generation element 284 (FIG. 11). Various aspects related to and/or including operation of the skew pattern generation element284 are described in association with at least FIGS. 13-14. For instance, FIG. 13 is a block diagram 350 schematically representing application of a non-affine transform 354 to a pixel data array 352, according to an example of the present disclosure.

As shown in FIG. 13, the pixel coordinate data array 352 is subjected to a series of non-affine transformations 354 with each non-affine transformation 354 applied in at least one three orientations (X, Y, and/or Z) to generate an array 356 of skew patterns 357 that include all the skew possibilities. The pixel coordinate data array 352 is sized (e.g. 64 x 64 in just one example) to reflect the dimensions of the capture data in the target object image 14 (FIG. 1). The array of pre-generated skew patterns 357 exhibits each permutation of a rotation (in X, Y, and/or Z orientations) of the array of pixel data. In one aspect, by applying the non-affine transform 354, the distance of values is exaggerated via the transformation which yields an accurate skew, in which a change in distance corresponds to a decrease in overall size. For instance, as skew occurs an image would shrink though we may still have 64×64 coordinates, such that the number of used coordinates decreases in size the more skew is applied. Accordingly, as further addressed later in association with at least FIG. 16, this phenomenon is accounted for via pixel occlusion maps.

The array 356 includes a plurality of different skew patterns generated without specific reference to any particular target object image or reference object image. In this sense, these skew patterns are sometimes referred to as pre-generated skew patterns at least because they are generated before any particular target object image or reference object image is considered. Accordingly, in some instances, these pre-generated skew patterns may sometimes be referred to as being target agnostic or generic until or unless they become associated with a reference object image (after application of pixel occlusion map element 286), as described later in association with at least FIG. 16.

FIG. 14 is a block diagram schematically representing pre-generated skew patterns 357, according to an example of the present disclosure. As shown in FIG. 14, the pre-generated skew patterns 257 includes a no skew pattern 358 and skew patterns 359, with each different skew pattern 359 expressing a unique degree of skew in at least one orientation (X, Y, and/or Z) resulting from the non-affine transformation process described in association with at least FIG. 13. The no skew pattern 358 provides for the case in which no skew is applied to the pixel data array and which may be matched to a target object image in which no skew is detected.

FIG. 15 is a block diagram schematically representing a library 370 of reference object images, according to an example of the present disclosure. In some examples, at least reference object image association element 287 of comparison engine 174 (FIG. 11) includes and/or has access to reference object images against which target object images may be compared to detect skew in the target object image (after processing of the target object image and reference object image as described herein). In general terms, the library 370 may be stored in memory 554 (FIG. 19). In some examples, each reference object, which is the subject of a reference object image, has a size, shape, and/or identifiable features which are consistently present in large numbers of the particular type of object such that one may expect, with a reasonably high degree of confidence, that a reliable determination can be made about whether an eligible target object image matches the reference object image. Accordingly, library 370 includes a plurality of such reference object images against which target object images may be reliably matched, subject to at least the aspects of skew detection as described within the present disclosure and/or subject to other aspects of matching, such as aspects of radial histogram matching.

However, prior to any comparison of the pre-generated skew patterns 357 with a reference object image of library 370 via reference object image association element 287, further processing of the skew patterns 357 is performed.

Accordingly, as previously noted, in some examples the comparison engine 174 includes a pixel occlusion map generation element 286 (FIG. 11) and a reference object image association element 287 (FIG. 11). Various aspects related to and/or including operation of the pixel occlusion map generation element 286 and reference object image association element 287 are described in association with at least FIG. 16, according to an example of the present disclosure.

Accordingly, with reference to FIG. 16, in some examples the pre-generated skew patterns 357 are subject to rendering to generate an array 382 of pixel occlusion maps 384. In particular, prior to employing the pre-generated skew patterns 357, one may account for the final output array (for each pre-generated skew pattern 357) having points that overlap as they have been translated in rotation in the third-dimension (Z). In some examples, further processing can involve implementing a Z-buffer protocol to process the data array (for each pre-generated skew pattern) to create a minimum Z boundary and maximum Z boundary, and output a pre-rendered array that is bounded. A rendering protocol can then draw (e.g. process) the points from back to front and keep track of which points overlap other points.

Accordingly, this rendering process determines the location in a two-dimensional (2D) plane of view of what would be visible. This creates a pixel occlusion map 384 for the given coordinates for the given angles of skew in X, Y and Z orientations. If one considers the new size of the valid coordinates and the pixel occlusion map 384, a simple coordinate comparison system can process an actual logo or feature image and consider the valid pixel offsets (while excluding non-valid pixel coordinates) and their new locations given the occlusion map.

Stated differently, while accounting for overlapping data points, one can construct a pixel occlusion map 384 which represents valid points (e.g. pixels) suitable for further use as a template for association with a reference object image to detect skew in a target object image. Accordingly, via this process the mapping of rotation angles in potentially all three X, Y and Z orientations is achieved at the same time, thereby making it possible to maintain a pre-generated and pre-computed set of skew mappings which would be target agnostic.

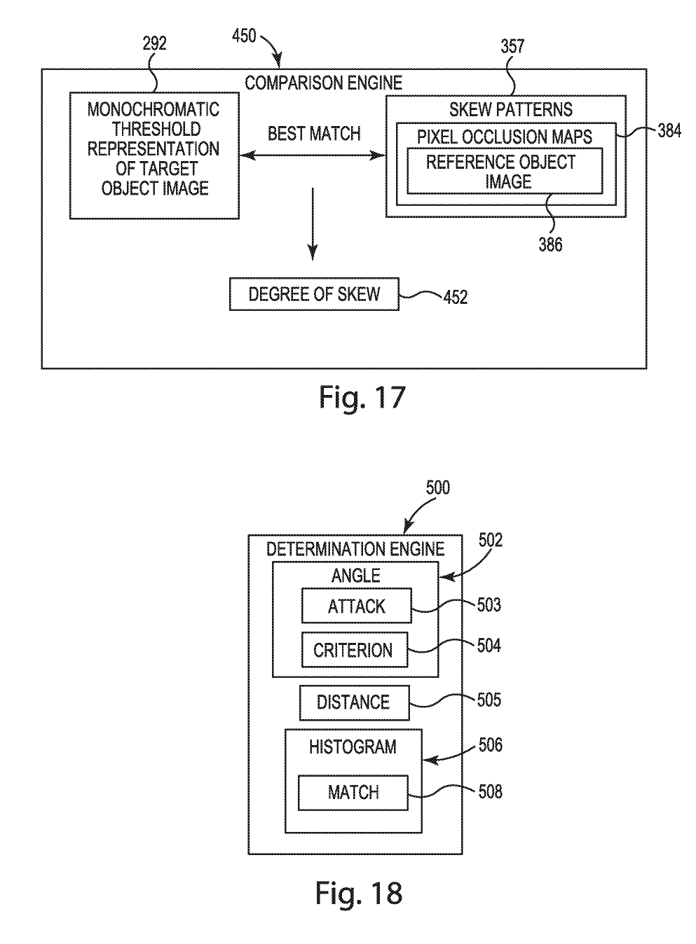

As further shown in FIG. 16, each pixel occlusion map 384 of array 382 is associated with a monochromatic representation of a reference object image 386 to produce an array or series 387 of reference object-specific skew patterns 388, which are suitable for comparison with a monochromatic representation of the target object image, as further depicted in FIG. 17. As shown in FIG. 17, upon determining a best match from such comparisons, the comparison engine 450 can identify a degree of skew of the target object image. It will be understood that in some examples the comparison engine 450 in FIG. 17 includes at least substantially the same features and attributes as the comparison engine 174 in FIG. 11, with comparison engine 450 in FIG. 17 depicting at least one of the aspects of operation of the comparison engine 174.

Accordingly, via at least some examples of the present disclosure in which skew patterns are pre-generated without regard to a specific reference object image, one can take bitmap data for a reference object image (such as but not limited to the HP logo in FIG. 5) and determine which points would be visible for all possible skew angles without re-computing the non-affine transforms (354 in FIG. 13). In just one aspect, via the skew pre-generation process and the building of pixel occlusion maps 384, it can be known that, for example, the coordinate at 4,5 is not visible, and overwritten by the data at coordinate 4,4 due to the specific characteristic of the skew angle.

Given that at least some examples of the present disclosure may enable one to avoid calculating and storing all possible reference object images (e.g. HP logos) as skewed non-affine transformed data, a single set of data for the reference object image (e.g. an HP logo) can be stored and yet it would be possible to detect many skewed, rotated, and scaled reference object images (e.g. HP logos).

Accordingly, via at least some examples of the present disclosure, a given logo (or similar logos) with skew can be evaluated relative to several thousand possible skew scenarios (each with varying levels of accuracy of match) without involving that the logo or feature is directly converted to these skew patterns. It will be understood that a logo is just one example of many different types of target objects for which skew detection may be applied according to at least some examples of the present disclosure.

In one aspect, at least some examples of the present disclosure provide for real-time detection of any pattern with skew, scale and rotation. In another aspect, this process does not involve the skew being a special case because a no skew pattern (e.g. 358 in FIG. 14) may be the first pattern generated, resulting in the ability to use the same process for all patterns (it just so happens that the first skew pattern has no rotation thus no skew).

Once a degree of skew is identified, if any is present at all, then further information regarding a target object image may be determined. FIG. 18 is a block diagram schematically representing a determination engine 500, according to an example of the present disclosure. In some examples, determination engine 500 includes at least some of substantially the same features and attributes as determination engine 176, as previously described in association with at least FIG. 9. As shown in FIG. 18, in some examples determination engine 500 includes an angle element 502, a distance element 505, and/or histogram functions 506 including a match parameter 508. In some examples, the angle element 502 includes an attack parameter 503 and a criterion parameter 504.

In some examples, the attack parameter 503 identifies an angle-of-attack determined from the detected skew, in which the identified angle-of-attack corresponds to the angle from which the imager or other sensor obtained the target object image. At least FIGS. 4-5 and 7 provide further detail regarding identifying the angle-of-attack from an imager.

In some examples, the angle element 502 includes a criterion parameter 504 to specify a criterion against which the identified angle-of-attack may be evaluated. In some examples, the criterion parameter 504 enables specifying the criterion as a particular maximum allowable angle deviation from an orthogonal line of sight (e.g. 52 in FIGS. 3-4; 152 in FIG. 7) toward the target object while obtaining the target object image. In some examples, the maximum allowable angle deviation specified via the criterion parameter 504 can be range, such as 1 to 45 degrees or another specifiable range. In some examples, the angle or range of angles specified by the criterion parameter 504 may depend on factors such as the type of target object, its size, shape, etc.

In some examples, when the identified angle-of-attack does not meet the value specified by the criterion parameter 504, the determination engine 500 prevents the histogram element 506 from performing any histogram matching or comparison functions (via match parameter 508) because such comparisons may lead to false positives. In some examples, a user/operator is notified that the angle-of-attack is too large and may suggest corrective action in taking a subsequent image of a target object. In some examples, such notification may occur via notification element 520 as later described in association with at least FIG. 19.

For instance, in some applications, one may attempt to use image recognition to record and/or evaluate wear on an automobile tire, which may include a tessellating pattern. In such instances, determining the angle of attack may help determine whether a new, better image of the tire should be obtained and/or whether the target object image (e.g. of the tire) is acceptable for further evaluation and use. For instance, in one example, upon determining that the angle of attack deviates too much from an orthogonal line of sight, the operator may be informed to change the angle of attack, such as to orient the image to become more orthogonal relative to a presenting surface of the target object.

Accordingly, this information may provide a go, no-go decision criteria which can be used to direct a sensor, automation, or person on how to capture the image better, or which can be used in real-time on how to capture a given image right the first time.

In some examples, the distance element 505 may employ the identified degree of skew (e.g. an angle) as an attribute of information for a detected pattern. For instance, if one detects the target object image (e.g. HP logo in FIG. 5) at a given distance, with mapping to skew angle of X, Y, and Z, then one can calculate the distance to the logo (assuming the size of the logo is known). In one aspect, by utilizing a range finder or any type of distance calculation that is out-of-band from the imager used to obtain the target object image, false positives may be mitigated.

In some examples, via the match parameter 508 of the histogram element 506 (FIG. 18), a first radial histogram for the target object image can be determined and a second radial histogram for a reference object image can be determined. The first and second radial histograms are evaluated and compared to determine whether the target object image matches the reference object image.

FIG. 19 is a block diagram schematically representing a control portion 550 and a user interface 560, according to one example of the present disclosure. In some examples, control portion 550 includes a controller 552 and a memory 554 to store at least manager 555 to perform at least skew detection 556 in the manner described herein. In some examples, control portion 550 provides one example implementation by which device 170, 180 (FIGS. 7-8) may be implemented.

Controller 552 of control portion 550 can comprise at least one processor 553 and associated memories that are in communication with memory 554 to generate control signals, and/or provide storage, to direct operation of at least some components of the systems, devices, engines, elements, components, functions, and/or parameters described throughout the present disclosure. In some examples, these generated control signals include, but are not limited to, employing device 170, 180 and/or manager 555 to manage detecting skew 556 and the associated functions and activities described in at least some examples of the present disclosure.

In response to or based upon commands received via a user interface 560 and/or via machine readable instructions, controller 552 generates control signals to implement at least timing and sequence of the operation of the various aspects of in a method and/or device for detecting skew in accordance with at least some examples of the present disclosure. In some examples, controller 552 is embodied in a general purpose computer while in other examples, controller 552 is embodied in an imager 32 described herein generally, or incorporated into or associated with at least some of the components described throughout the present disclosure.

For purposes of this application, in reference to the controller 552, the term processor shall mean a presently developed or future developed processor (or processing resource) that executes sequences of machine readable instructions contained in a memory. In some examples, execution of the sequences of machine readable instructions, such as those provided via memory 554 associable with control portion 550 to cause the processor to perform actions, such as operating controller 552 to implement at least skew detection and/or other related functions, as generally described in (or consistent with) at least some examples of the present disclosure. The machine readable instructions may be loaded in a random access memory (RAM) for execution by the processor from their stored location in a read only memory (ROM), a mass storage device, or some other persistent storage, as represented by memory 554. In some examples, memory 554 comprises a volatile memory. In some examples, memory 554 comprises a non-volatile memory. In some examples, memory 554 comprises a computer readable tangible medium providing non-transitory storage of the machine readable instructions executable by a process of controller 552. In other examples, hard wired circuitry may be used in place of or in combination with machine readable instructions to implement the functions described. For example, controller 552 may be embodied as part of at least one application-specific integrated circuit (ASIC). In at least some examples, the controller 552 is not limited to any specific combination of hardware circuitry and machine readable instructions, nor limited to any particular source for the machine readable instructions executed by the controller 552.

In some examples, user interface 560 provides for the simultaneous display, activation, and/or operation of at least some of the various systems, devices, engines, elements, components, functions, and/or parameters of device 170, 180, manager 555, and/or control portion 550 and/or of at least the various aspects of skew detection operations and/or related functions, as described throughout the present disclosure.

In some examples, at least some portions or aspects of the user interface 560 are provided via a graphical user interface (GUI). In some examples, user interface 560 includes an input 562 and a display 564, which may or may not be combined in a single element, such as a touch screen display. In some examples, user interface 560 is provided via a desktop computer, a terminal associated with a server, a laptop computer, a tablet, phablet, mobile phone, smart watch, and the like.

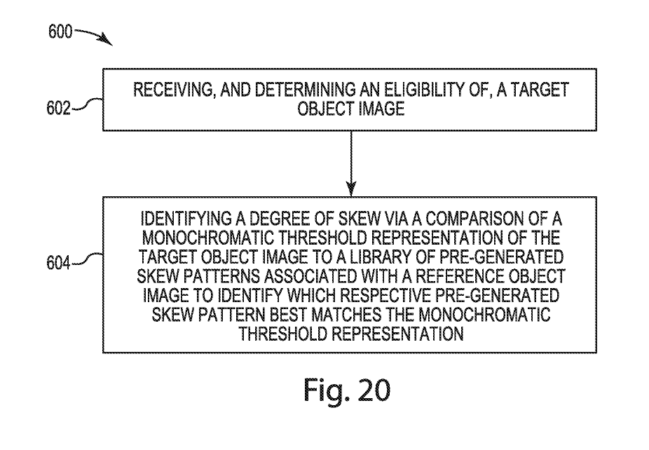

FIG. 20 is a block diagram schematically representing a method 600 of identifying a degree of skew, according to an example of the present disclosure. In some examples, method 600 is performed via at least some of the devices, units, engines, functions, parameters, components, elements, etc. as previously described in association with at least FIGS. 1-19. In some examples, method 600 is performed via at least some of the devices, units, engines, functions, parameters, components, elements, etc. other than previously described in association with at least FIGS. 1-19.

As shown at 602 in FIG. 20, in some examples method 600 includes receiving, and determining an eligibility of, a target object image. As further shown at 604 in FIG. 20, method 600 includes identifying a degree of skew in the target object image via a comparison of a monochromatic threshold representation of the target object image to a library of pre-generated skew patterns associated with a reference object image to identify which respective pre-generated skew pattern best matches the monochromatic threshold representation. In one aspect, each pre-generated skew pattern corresponds to a non-affine transformation of a two-dimensional pixel array performed along at least one of three perpendicular orientations (e.g. X, Y, and/or Z).

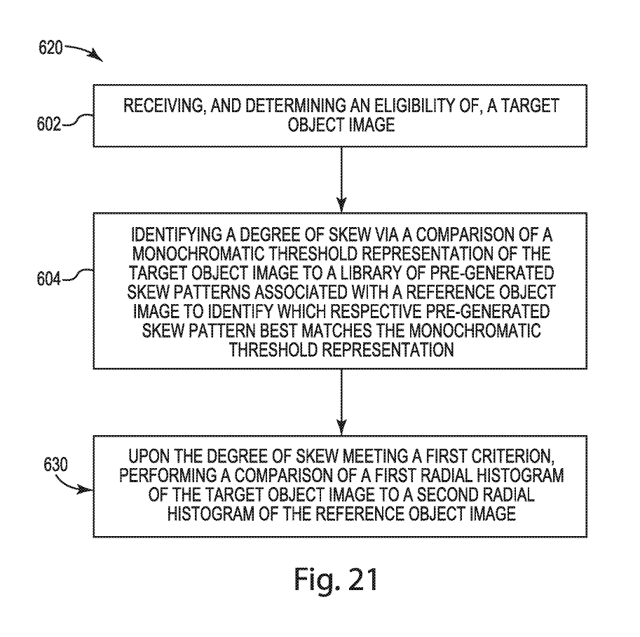

FIG. 21 is a block diagram schematically representing a method 620 of identifying skew and histogram comparison, according to an example of the present disclosure. In some examples, method 620 is performed in association with and/or using the results of method 600 as described in association with FIG. 20. Accordingly, as shown at 602 in FIG. 21, in some examples method 620 includes receiving, and determining an eligibility of, a target object image. As further shown at 604 in FIG. 21, method 620 includes identifying a degree of skew in the target object image via a comparison of a monochromatic threshold representation of the target object image to a library of pre-generated skew patterns associated with a reference object image to identify which respective pre-generated skew pattern best matches the monochromatic threshold representation. In one aspect, each pre-generated skew pattern corresponds to a non-affine transformation of a two-dimensional pixel array performed along at least one of three perpendicular orientations (e.g. X, Y, and/or Z). As shown at 630 in FIG. 21, upon the degree of skew meeting a first criterion, performing a comparison of a first radial histogram of the target object image to a second radial histogram of the reference object image to determine if the target object image matches the reference object image.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. A device comprising:
an eligibility engine to receive, and determine an eligibility of, a target object image;
a comparison engine to compare a monochromatic threshold representation of the target object image to each skew pattern of a library of pre-generated skew patterns associable with a reference object image to identify which pre-generated skew pattern best matches the monochromatic threshold representation; and
a determination engine to determine, from the identify skew pattern, at least one of:
an angle of attack from which the target object image was captured relative to a reference angle; and
a distance between a target object within the target object image and an imager from which the target object image was captured.

2. The device of claim 1, in which the eligibility engine is to determine eligibility of the image according at least one of:
a selectable minimum resolution of the target object image; and
a selectable minimum size and a selectable maximum size of the target object image given a range of distance between the sensor and the target object at which the target object image is obtained.

3. The device of claim 1, wherein each pre-generated skew pattern corresponds to a non-affine transformation of a two-dimensional pixel data array along at least one of three perpendicular orientations.

4. The device of claim 3, wherein the comparison engine includes:
a pixel occlusion map generation element to determine a pixel occlusion map for each respective pre-generated skew pattern to identify pixels of the two-dimensional pixel data array which would be visible and to identify pixels which would be non-visible in a two-dimensional viewing plane for each respective pre-generated skew pattern.

5. The device of claim 4, in which the comparison engine includes a reference object image association element to associate a reference object image with each pixel occlusion map to map coordinates of each pixel in the reference object image to coordinates of each pixel in each of the respective pre-generated pixel occlusion maps to generate reference object image-specific pixel occlusion maps,
with the comparison engine to use the respective reference object-specific occlusion maps for the comparison with the monochromatic threshold representation of the target object image.

6. The device of claim 1, comprising:
an angle criterion element to compare the determined angle of attack relative to a first criterion; and
a histogram matching element to perform histogram matching of the target object image upon the determined angle of attack meeting the first criterion.

7. The device of claim 6, in which the histogram matching element is to:
determine a first radial histogram for the target object image;
determine a second radial histogram for a reference object image; and
compare the first and second radial histograms to determine whether the target object image matches the reference object image.

8. A device including a processing resource to execute machine-readable instructions, stored in a non-transitory medium, to:
receive, and determine an eligibility of, a target object image; and
identify a degree of skew in the target object image via comparison of a monochromatic threshold representation of the target object image to a library of pre-generated skew templates associated with a reference object image to identify which pre-generated skew template best matches the monochromatic threshold representation, wherein each pre-generated skew template corresponds to a non-affine transformation of a two-dimensional pixel array performed along at least one of three perpendicular orientations.

9. The device of claim 8, wherein the association of the pre-generated respective skew templates with the reference object image includes instructions to:
generate the skew templates according to the two-dimensional pixel array; and
map each pixel in the reference object image to each pixel in the respective generated skew template for the reference object image.

10. The device of claim 9, wherein the instructions to compare includes instructions to:
determine a pixel occlusion map for each respective pre-generated skew template to identify which pixels of the two-dimensional pixel array would be visible and which pixels of the two-dimensional pixel array would be non-visible in a two-dimensional viewing plane for the respective pre-generated skew template; and
use the respective determined pixel occlusion map for each respective pre-generated skew template to make the comparison with the monochromatic threshold representation of the target object image.

11. The device of claim 8, the instructions to:
determine, from the identified skew template, at least one of:
an angle of attack from which the target object image was captured relative to a reference angle; and
a distance between a target object within the target object image and an imager from which the target object image was captured.

12. The device of claim 9, the instructions to:
determine whether the degree of skew is within a first criteria; and upon such determination, perform histogram matching via instructions to determine a first radial histogram for the target object image;
determine a second radial histogram for a reference object image;
and
compare the first and second radial histograms to determine whether the target object image matches the reference object image.

13. A method comprising:
receiving, and determining an eligibility of, a target object image; and
identifying a degree of skew in the target object image via a comparison of a monochromatic threshold representation of the target object image to a library of pre-generated skew patterns associated with a reference object image to identify which respective pre-generated skew pattern best matches the monochromatic threshold representation, wherein each pre-generated skew pattern corresponds to a non-affine transformation of a two-dimensional pixel array performed along at least one of three perpendicular orientations; and
upon the degree of skew meeting a first criterion, performing a comparison of a first radial histogram of the target object image to a second radial histogram of the reference object image to determine if the target object image matches the reference object image.

14. The method of claim 13, comprising:
evaluating the degree of skew to determine at least one of:
an angle of attack from which the target object image was captured relative to a reference angle; and
a distance between a target object within the target object image and an imager from which the target object image was captured.

15. The method of claim 13, wherein associating the pre-generated respective skew patterns with the reference object image includes generating the skew patterns according to the two-dimensional pixel array and mapping coordinates of each pixel in the reference object image to coordinates of each pixel in the respective generated skew patterns for the reference object image, and
wherein the comparison includes:
determining a pixel occlusion map for each respective pre-generated skew pattern to identify pixels of the two-dimensional pixel array which would be visible and which would be non-visible in a two-dimensional viewing plane for the respective pre-generated skew pattern; and
using the respective determined pixel occlusion map for each respective pre-generated skew pattern to make the comparison with the monochromatic threshold representation of the target object image.
